(19) United States
(12) Patent Application Publication
(10) Pub. No.: US 2012/0147734 A1
(43) Pub. Date: Jun. 14, 2012

(54) APPARATUS AND METHOD FOR RETRANSMITTING DATA BASED ON HARQ SCHEME IN WIRELESS COMMUNICATION SYSTEM

(75) Inventors: Jeong Ki Kim, Anyang-si (KR); Su Nam Kim, Anyang-si (KR); Ki Seon Ryu, Anyang-si (KR); Young Soo Yuk, Anyang-si (KR)

(73) Assignee: LG ELECTRONICS INC., Seoul (KR)

(21) Appl. No.: 13/390,324

(22) PCT Filed: Jul. 22, 2010
(86) PCT No.: PCT/KR2010/004812

§ 371 Date: Feb. 13, 2012

Related U.S. Application Data
(60) Provisional application No. 61/234,656, filed on Aug. 18, 2009.
(60) Provisional application No. 61/238,137, filed on Aug. 28, 2009.
(60) Provisional application No. 61/237,704, filed on Aug. 28, 2009.
(60) Provisional application No. 61/238,219, filed on Aug. 31, 2009.

(30) Foreign Application Priority Data
Mar. 26, 2010 (KR) 10-2010-0027383

(51) Int. Cl. H04W 4/00

(52) U.S. Cl. 370/216

(57) ABSTRACT

A method for retransmitting data using an HARQ method and a mobile station using the same in a wireless telecommunications system are disclosed herein. When all bits of a resource index field in an uplink basic assignment A-MAP received from a base station through a specific frame are set to 1, the mobile station may not retransmit an HARQ sub-packet from an uplink subframe within the specific frame. In this case, the mobile station may retransmit an HARQ sub-packet from an uplink subframe within a frame subsequent to the specific frame. At this point, the uplink subframe and resource index of the subsequent frame respectively correspond to the subframe and resource index having the same index and resource index of an uplink subframe predetermined in association with the retransmission of the mobile station in a previous frame. The resource index corresponds to information indicating where the assigned resource is positioned within the corresponding subframe and how large the size of the assigned resource is. Alternatively, the mobile station may receive once again the uplink basic assignment A-MAP, so as to retransmit the HARQ sub-packet from an uplink subframe designated by the uplink basic assignment A-MAP.

### TECHNICAL FIELD

The present invention relates to a wireless (or radio) telecommunications system and, more particularly, a method for retransmitting data using an HARQ method and a mobile station using the same.

### BACKGROUND ART

A Hybrid Automatic Retransmission Request (HARQ) refers to an enhanced automatic retransmission request method, which combines originally transmitted information (or data) with newly transmitted information (or data) and decodes the combined information, so as to reduce the number of retransmissions in accordance with errors occurring during an initial data transmission. Such HARQ method corresponds to a technology used not only in an IEEE 802.16m system but also in other mobile telecommunications systems. Hereinafter, a method of assigning resources for an uplink HARG in a related art IEEE 802.16 system will now be briefly described.

A user equipment receiving an Uplink Basic Assignment A-MAP Information Element (IE) from a base station transmits a sub-packet of HARQ data through resources assigned by the uplink basic assignment A-MAP IE. The base station attempts to decode a data burst. And, when the base station successfully decodes the data burst, the base station transmits an acknowledgment (ACK) to the user equipment. However, on the other hand, if the base station fails to decode the data burst, the base station transmits a Negative Acknowledgment (NACK) to the user equipment. When the base station assigns resources to the user equipment for retransmission, the base station may not transmit the uplink basic assignment A-MAP IE. In this case, the base station assigns resources to the user equipment from a subframe for retransmission to the same position and in the same size as the assigned region for the previous sub-packet. In case the base station transmits an uplink basic assignment A-MAP IE in order to assign resources for retransmission, the base station assigns resources to a region designated by the respective A-MAP.

The user equipment receiving a NACK signal from the base station performs a retransmission procedure. During the retransmission procedure, if the user equipment does not receive an uplink basic assignment A-MAP IE for transmitting an HARQ data burst, the user equipment transmits a next sub-packet through the resource assigned from the transmission of the last sub-packet having the same ACID. In order to deliver the control information for the retransmission, the base station may transmit an uplink basic assignment A-MAP IE to the user equipment. In this case, if the user equipment receives the uplink basic assignment A-MAP IE for the retransmission, the user equipment shall perform an HARQ retransmission designated by the uplink basic assignment A-MAP IE.

FIG. 1 illustrates an example of a related art uplink HARQ procedure.

Referring to FIG. 1, the base station transmits an uplink basic assignment A-MAP IE, which indicates that an uplink resource for data retransmission of the user equipment has been assigned to region A, to the user equipment (S110). The user equipment receiving the uplink basic assignment A-MAP IE from the base station transmits a sub-packet of an HARQ burst through the resource region (region A) designated by the corresponding IE (S120). If an error occurs in the packet transmitted by the user equipment, and, therefore, if the base station is incapable of decoding the packet, the base station transmits a NACK signal to the user equipment, in order to notify the user equipment of the error occurred in the transmitted packet (S130). Thereafter, in order to allow the user equipment to retransmit the erroneous packet (or packet having an error occurred therein) at a designated time point, the base station assigns a resource having the same position and size as those of the resource used for the transmission of the last erroneous packet without the uplink basic assignment A-MAP IE to the user equipment (S140). If the user equipment receives the NACK signal but fails to receive the uplink basic assignment A-MAP IE for the retransmission, the user equipment uses the regions having the same position and size of those of the resource region (region A) that was last transmitted, so as to transmit a retransmission packet (S150). Accordingly, if the base station successfully receives the packet retransmitted from the user equipment through the assigned region A, the base station transmits an ACK signal to the user equipment as a response to the successful reception (S160). As described above, in order to enable the user equipment to retransmit a packet having an error occurred therein, the base station assigns a region having the same position and size as those of the resource region that was last transmitted from the user equipment, thereby notifying the user equipment.

FIG. 2 illustrates another example of a related art uplink HARQ procedure.

Referring to FIG. 2, as described in FIG. 1, the base station transmits an uplink basic assignment A-MAP IE, which indicates that an uplink resource for data retransmission of the user equipment has been assigned to region A (S210). The user equipment receiving the uplink basic assignment A-MAP IE from the base station transmits a sub-packet of an HARQ burst through the resource region (region A) designated by the corresponding IE (S220). If an error occurs in the packet transmitted by the user equipment, and, therefore, if the base station fails to decode the packet, the base station transmits a NACK signal to the user equipment, in order to notify the user equipment of the error occurred in the transmitted packet (S230). Thereafter, when the base station assigns a resource in order to allow the user equipment to retransmit the erroneous packet (or packet having an error occurred therein) at a designated time point, the base station transmits the uplink basic assignment A-MAP IE to the user equipment in order to assign a resource having different information (e.g., a different position or a different size) from that of the resource most recently assigned with respect to the corresponding ACID (S240). If the user equipment receives the NACK signal and also receives the uplink basic assignment A-MAP IE for the retransmission, the user equipment transmits the retransmission packet to a resource region (region B) designated by the corresponding A-MAP IE (S250). Accordingly, if the base station successfully receives the packet retransmitted from the user equipment through the assigned region (region B), the base station transmits an ACK signal to the user equipment as a response to the successful reception (S260). As described above, in order to enable the user equipment to retransmit a packet having an error occurred therein, the base station assigns a new uplink resource region (region B) to the user equipment and notifies the user equipment of the newly assigned region.

During the HARQ procedure, the assignment of A-MAP IE and the feedback respective to the HARQ sub-packet and sub-packet are performed at a pre-decided time. In an uplink, the retransmission of the HARQ sub-packet of the user equipment is performed at a time defined in advance.

FIG. 3 illustrates an HARQ transmission timing in an IEEE 802.16m system, when the processing time of a data burst corresponds to 3 subframe sections, and when the ratio of the number of downlink/uplink subframes within one frame is 5:3.

Referring to FIG. 3, when the base station transmits an uplink MAP from a subframe (310) having a downlink subframe index of 1 within a first frame to the user equipment, the user equipment transmits uplink data from a subframe (320) having an uplink subframe index of 0 within the first frame to the base station, the corresponding subframe (320) being positioned after 3 subframes from the subframe (310) having the downlink subframe index of 1. When an uplink data burst is transmitted from the user equipment through the subframe (320) having an uplink subframe index of 0 within the first frame, the base station transmits HARQ feedback information to the user equipment from a subframe (330) having a downlink subframe index of 1 within a second frame, the corresponding subframe (330) being positioned after 3 subframes from the subframe (320) having the uplink subframe index of 0. If a NACK signal is transmitted by the base station from the subframe (330) having the downlink subframe index of 1 within the second frame, a resource for retransmission may be assigned to a subframe (340) having an uplink subframe index of 0 within the second frame. Herein, the corresponding subframe (340) is positioned after 3 subframes from the subframe (330) having the downlink subframe index of 1 within the second frame. Alternatively, when the base station transmits a NACK signal to the user equipment, an Uplink Basic Assignment A-MAP IE may be transmitted from a subframe from which the NACK signal is transmitted, in order to change (or modify) the uplink resource information.

As described above, when the uplink HARQ operates synchronously, at the retransmission point of a specific packet, due to the transmission of a different (or another) packet, the resource for the retransmission cannot be assigned at the corresponding point. In this case, the base station may not be capable of transmitting a MAP for retransmission to the user equipment. If the user equipment fails to receive the uplink basic assignment A-MAP IE at the point of retransmission, the user equipment may transmit the retransmission packet by using the same region as that of the resource region most recently transmitted with respect to the same ACID. However, such packet retransmission may interrupt (or obstruct) the transmission of another packet. Such problems will hereinafter be described in more detail.

FIG. 4 illustrates a drawing describing the problems that may occur when the base station is incapable of assigning a resource for retransmission.

Referring to FIG. 4, the base station transmits an uplink basic assignment A-MAP IE, which indicates that an uplink resource for data retransmission of the user equipment has been assigned to region A (S410). The user equipment receiving the uplink basic assignment A-MAP IE from the base station transmits a sub-packet of an HARQ burst through the resource region (region A) designated by the corresponding IE (S420). If an error occurs in the packet transmitted by the user equipment, and, therefore, if the base station is incapable of decoding the packet, the base station transmits a NACK signal to the user equipment, in order to notify the user equipment of the error occurred in the transmitted packet (S430). Thereafter, when the user equipment is incapable of assigning a resource for retransmission with respect to the erroneous packet (or packet having an error occurred therein) at a designated time point, the base station does not transmit an uplink A-MAP for resource assignment to the user equipment. Accordingly, the user equipment receives only the NACK signal without the A-MAP from the base station (S440). Since the user equipment fails to receive the uplink basic assignment A-MAP IE for retransmission from the base station, the user equipment uses a region having the same position and size of those of the most recently transmitted resource region (e.g., region A), so as to transmit a retransmission packet (S450). If the resource region transmitted by the user equipment is used by another user equipment, an error may occur in the packet transmitted from the other user equipment, thereby causing a critical problem, wherein the base station fails to receive a packet from any of the two user equipments. Therefore, this problem is required to be resolved.

### DISCLOSURE OF INVENTION

### Technical Problem

An object of the present invention devised to solve the problem lies on providing a method for retransmitting data using an HARQ (Hybrid Automatic Repeat reQuest) scheme.

Another object of the present invention devised to solve the problem lies on providing a mobile station for retransmitting data using an HARQ (Hybrid Automatic Repeat reQuest) scheme.

The technical objectives that are to be realized by the present invention will not be limited only to the technical objects pointed out herein. Other technical objectives that have not yet been mentioned herein will become apparent to those having ordinary skill in the art upon examination of the following.

### Solution to Problem

In an aspect of the present invention, a method for retransmitting data using an HARQ (Hybrid Automatic Repeat reQuest) scheme at a mobile station, the method includes receiving an uplink basic assignment A-MAP information element (IE) including a resource index field in a specific frame from a base station, and decoding the received uplink basic assignment A-MAP IE, wherein, the MS does not transmit, an HARQ sub-packet for an ACID, which is an HARQ channel identifier included in the uplink basic assignment A-MAP IE in the specific frame, when the resource index field is set to a specific value.

At this point, the specific value of the resource index field may correspond to a value that all bits of the resource index field are set to 0 or 1. And, a size of the resource index field may be a 9-bit or an 11-bit.

In another aspect of the present invention, a method for retransmitting data using an HARQ (Hybrid Automatic Repeat reQuest) scheme at a mobile station (MS), the method includes receiving a first uplink basic assignment A-MAP information element (IE) including a resource index field in a first frame from a base station; decoding the received first uplink basic assignment A-MAP IE; and when the resource index field is set to a specific value, instead of transmitting an HARQ sub-packet corresponding for an ACID, which is an HARQ channel identifier included in the first uplink basic assignment A-MAP IE, through a specific frame in a first frame, transmitting the HARQ sub-packet through a subframe having the same index as a specific subframe of the first frame, wherein the subframe is included in a second frame subsequent to the first frame.

At this point, the specific value of the resource index field corresponds to a value that all bits of the resource index are set to 0 or 1.

In another aspect of the present invention, a method for retransmitting data using an HARQ (Hybrid Automatic Repeat reQuest) scheme at a mobile station (MS), the method includes receiving a first uplink basic assignment A-MAP information element (IE) including a first resource index field in a first frame from a base station (BS); and decoding the received first uplink basic assignment A-MAP IE; and, when the first resource index field is set to a specific value, receiving a second uplink basic assignment A-MAP information element (IE) including a second resource index field in the first frame or a second frame from the base station; and retransmitting an HARQ sub-packet for an ACID, which is an HARQ channel identifier included in the first uplink basic assignment A-MAP IE, through a subframe designated by the second resource index field. Herein, the second resource index field may be set to have a value different from the specific value of the first resource index field.

In another aspect of the present invention, a mobile station (MS) for retransmitting data using an HARQ (Hybrid Automatic Repeat reQuest) scheme, the mobile station includes a receiving module for receiving an uplink basic assignment A-MAP information element (IE) including a resource index field from a base station (BS); and a processor for decoding the received uplink basic assignment A-MAP IE, and for controlling the MS so that an HARQ sub-packet for an ACID, which is an HARQ channel identifier included in the uplink basic assignment A-MAP IE, is not retransmitted, when the resource index field is set to a specific value.

In another aspect of the present invention, a mobile station (MS) for retransmitting data using an HARQ (Hybrid Automatic Repeat reQuest) scheme, the mobile station (MS) includes a receiving module for receiving a first uplink basic assignment A-MAP information element (IE) including a resource index field in a first frame from a base station (BS); and

a processor for decoding the received uplink basic assignment A-MAP IE, and, when the resource index field is set to a specific value, instead of transmitting an HARQ sub-packet for an ACID, which is an HARQ channel identifier included in the first uplink basic assignment A-MAP IE, through a specific frame in a first frame, for controlling the MS so that the HARQ sub-packet is transmitted through a subframe having the same index as a specific subframe of the first frame, wherein the subframe is included in a second frame subsequent to the first frame; and a transmitting module for transmitting the HARQ sub-packet through a subframe having the same index as a specific subframe of the first frame, wherein the subframe is included in the second frame.

In a further aspect of the present invention, a mobile station (MS) for retransmitting data using an HARQ (Hybrid Automatic Repeat reQuest) scheme, the mobile station includes a receiving module receiving a first uplink basic assignment A-MAP information element (IE) including a resource index field in a first frame from a base station (BS); and a processor for decoding the received first uplink basic assignment A-MAP IE, and when the first resource index field is set to a specific value, and when receiving a second uplink basic assignment A-MAP information element (IE) including a second resource index field in the first frame or a second frame from the base station, for controlling the MS so that an HARQ sub-packet for an ACID, which is an HARQ channel identifier included in the first uplink basic assignment A-MAP IE, is retransmitted through a subframe designated by the second resource index field; and a transmitting module for retransmitting the HARQ sub-packet for the ACID, which is an HARQ channel identifier included in the first uplink basic assignment A-MAP IE, through a subframe designated by the second resource index field. Herein, the second resource index field may be set to have a value different from the specific value.

### Advantageous Effects of Invention

By retransmitting data using the HARQ method proposed in the present invention, the occurrence of errors occurring in accordance with an uplink packet transmission, when the base station is incapable of assigning (or allocating) uplink resources for retransmission of the user equipment, may be essentially prevented, and the telecommunication performance may be outstandingly enhanced accordingly.

The effects that can be achieved in the present invention will not be limited only to the effects pointed out in the description of the present invention. Other effects that have not yet been mentioned herein will become apparent to those having ordinary skill in the art upon examination of the following.

### BRIEF DESCRIPTION OF DRAWINGS

The accompanying drawings, which are included to provide a further understanding of the invention and are incorporated in and constitute a part of this application, illustrate embodiments of the invention and along with the description serve to explain the spirit and scope (or principle) of the invention.

FIG. 1 illustrates an example of a related art uplink HARQ procedure,

FIG. 2 illustrates another example of a related art uplink HARQ procedure,

FIG. 3 illustrates an HARQ transmission timing in an IEEE 802.16m system, when the processing time of a data burst corresponds to 3 subframe sections, and when the ratio of the number of downlink/uplink subframes within one frame is 5:3,

FIG. 4 illustrates a drawing describing the problems that may occur when the base station is incapable of assigning a resource for retransmission,

FIG. 5 illustrates an example indicating that an uplink resource which is to be assigned from the base station to the user equipment for retransmission does not exist,

FIG. 6 illustrates another example indicating that an uplink resource which is to be assigned from the base station to the user equipment for retransmission does not exist,

FIG. 7 illustrates another example indicating that an uplink resource which is to be assigned from the base station to the user equipment does not exist,

FIG. 8 illustrates an exemplary method of the base station for indicating to the user equipment that the base station cannot assign a resource region for retransmission from an uplink subframe associated to an uplink assignment relevance, and

FIG. 9 illustrates a diagram showing elements of the equipment (50).

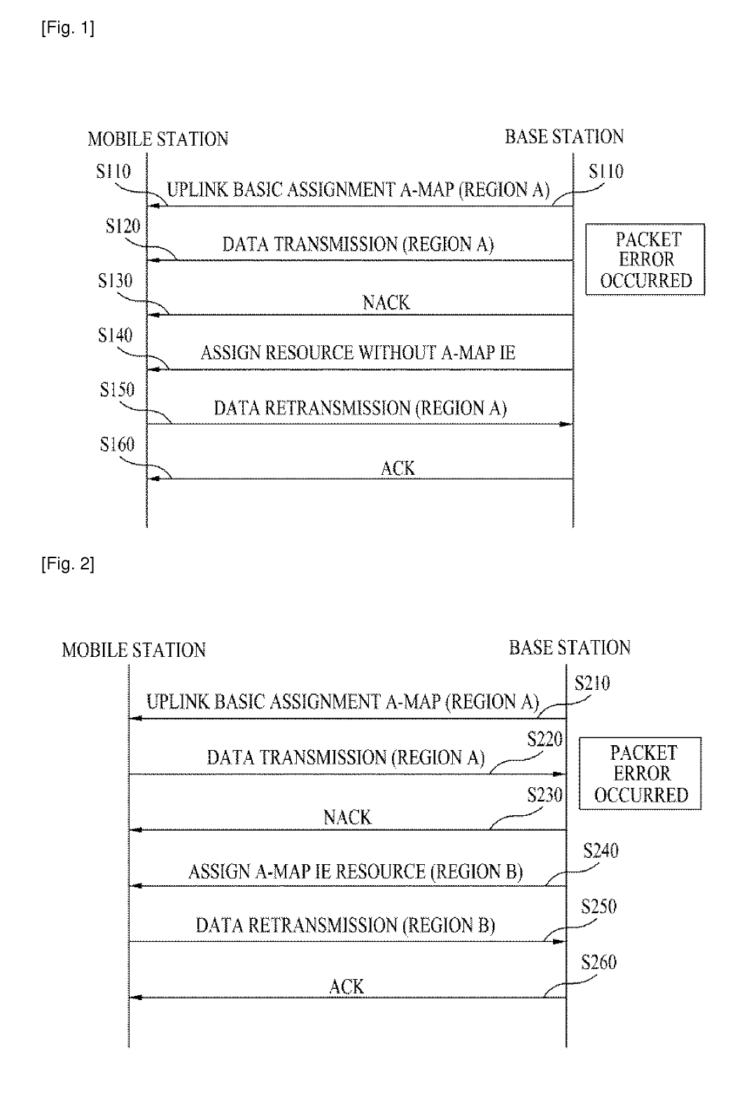

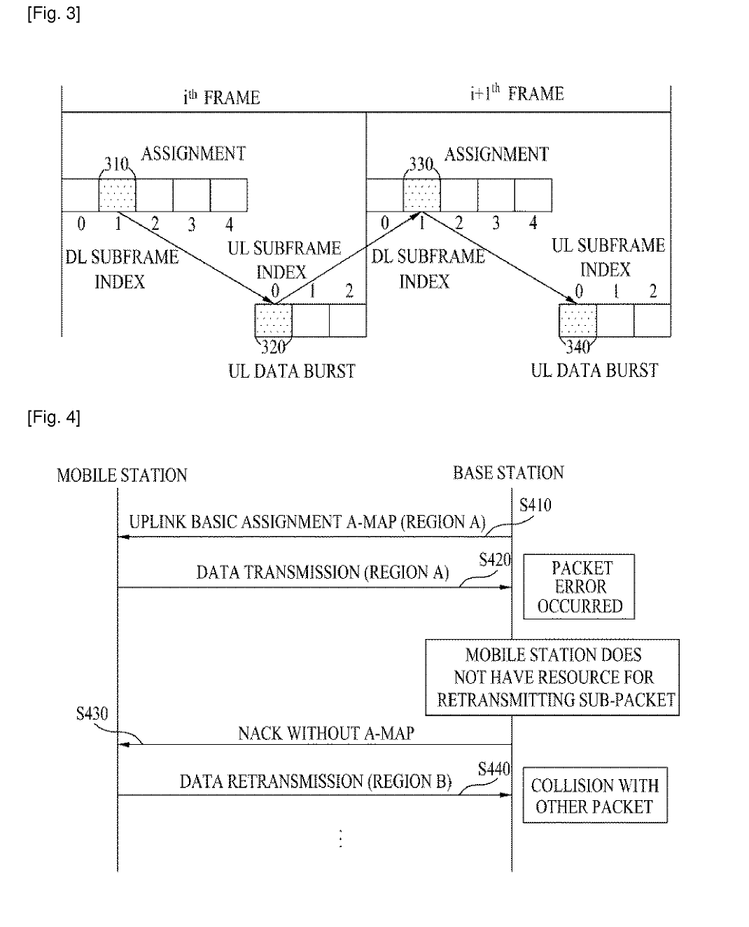

### BEST MODE FOR CARRYING OUT THE INVENTION

Reference will now be made in detail to the preferred embodiments of the present invention, examples of which are illustrated in the accompanying drawings. It should be understood that the present invention is not limited solely to the following embodiment. The following description includes specific details for providing a full understanding of the present invention. However, it is apparent to anyone skilled in the art that the present invention may also be embodied without such specific details. For example, the following detailed description is made under the assumption that the mobile telecommunications system corresponds to an IEEE 802.16 system. However, with the exception of the characteristic features of the IEEE 802.16 system, the present invention may also be applied to any other random mobile telecommunications system.

In some cases, to avoid any ambiguity in the concept of the present invention, structures or devices of the disclosure may be omitted, or the embodiment of the present invention may be illustrated in the form of block views focusing on the essential functions of each structure and device. Also, wherever possible, the same reference numbers will be used throughout the drawings to refer to the same or like parts.

Accordingly, in the following description of the present invention, it is assumed that a user equipment collectively refers to a mobile or fixed user-end equipment (or device), such as AMS (Advanced Mobile Station), UE (User Equipment), MS (Mobile Station), and so on. Also, it is assumed that a base station collectively refers to a random node, such as Node B, eNode B, Base Station, AP (Access Point), and so on, of a network end communicating with a terminal.

In a mobile communications system, a mobile station (AMS: Advanced Mobile Station) (or user equipment) may receive information through a downlink from a base station, and the mobile station may also transmit information through an uplink. Information that is transmitted or received by the mobile station may include data and diverse control information, and depending upon the usage or purpose of the information transmitted or received by the mobile station, a variety of physical channels may exist.

An AAI subframe used in the present invention refers to a structured data sequence of a predefined duration using by an AAI (Advanced Air Interface) and may also be generally referred to as a subframe. Also, an A-MAP (advanced MAP) used in the present invention may carry unicast service control information, thereby being transmitted to the user equipment. The unicast service control information may be broadly divided into user specific control information and non-user specific control information. Also, the user-specific control information may be more specifically divided into assignment (or allocation) information, HARQ feedback information, and power control information.

When the user equipment is incapable of assigning (or allocating) uplink resources for retransmission due to pre-assigned (or pre-allocated) resources, such as persistent allocation (or assignment), the base station may notify the user equipment in a unicast method at the corresponding time point that the resource for retransmission with respect to the specific ACID, which corresponds to an HARQ channel identifier, cannot be assigned (or allocated) from the current subframe. Accordingly, the user equipment does not transmit an unnecessary packet from the uplink subframe in association with an uplink (UL) allocation relevance.

Alternatively, at the corresponding time point, the base station may notify the user equipment that a resource will be assigned (or allocated) from an uplink subframe other than the uplink subframe corresponding to the uplink allocation relevance with respect to the specific ACID. Accordingly, instead of transmitting a packet from the uplink subframe related to the uplink allocation relevance, the user equipment may retransmit a packet from another uplink subframe indicated by the base station. More specifically, the base station may notify the user equipment that an uplink resource for retransmission will be assigned at a different time point.

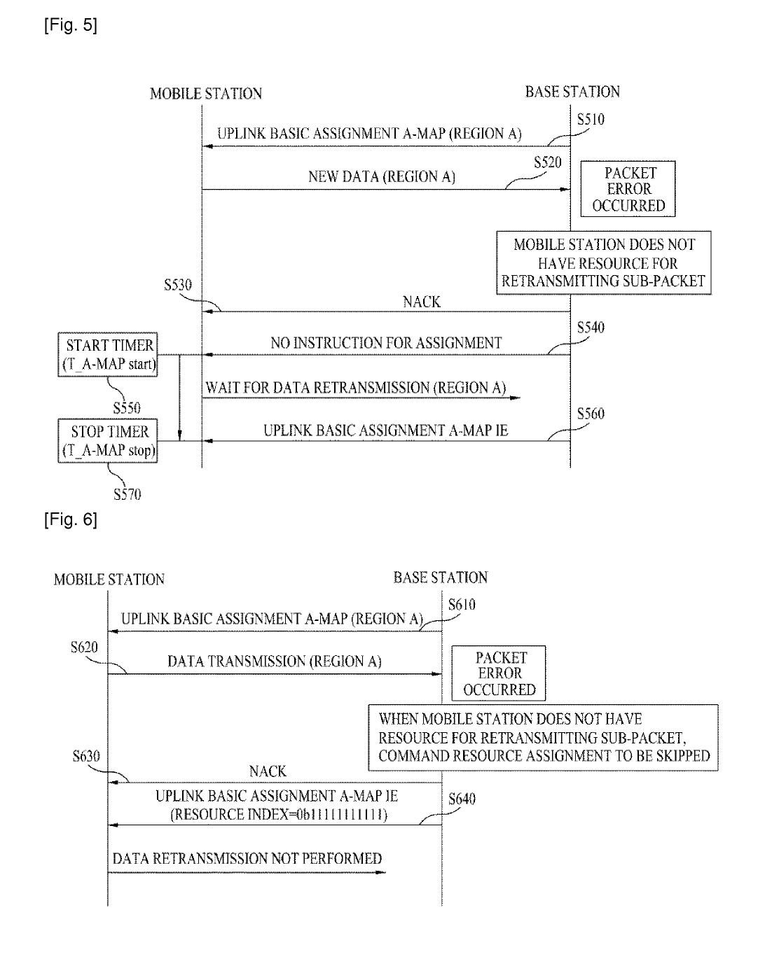

FIG. 5 illustrates an example indicating that an uplink resource which is to be assigned from the base station to the user equipment for retransmission does not exist.

Referring to FIG. 5, the base station may transmit an uplink basic assignment A-MAP IE, which indicates that an uplink resource for data retransmission of the user equipment has been assigned to region A (S510). The user equipment receiving the uplink basic assignment A-MAP IE from the base station may transmit new data through the resource region (region A) designated by the corresponding IE (S520). If an error occurs in the packet transmitted by the user equipment, and, therefore, if the base station is incapable of decoding the packet, the base station may transmit a NACK signal to the user equipment, in order to notify the user equipment of the error occurred in the transmitted packet (S530). Thereafter, when the user equipment is incapable of assigning a resource for retransmission with respect to the erroneous packet (or packet having an error occurred therein) at a designated time point, the base station may notify the user equipment from a downlink subframe, which transmits the NACK signal to the user equipment, that the base station cannot assign an uplink resource for the user equipment from the corresponding uplink subframe (S540).

As described above, when the user equipment receives information indicating that a resource for retransmission cannot be assigned from a corresponding uplink subframe along with the NACK signal (S540), the user equipment does not retransmit the packet from the corresponding uplink subframe to the base station. Accordingly, when the user equipment receives notification that therein no uplink resource assigned from the base station, a timer (T_A-MAP) for receiving the uplink basic assignment A-MAP IE for retransmission with respect to the corresponding ACID is initiated (S550). Then, the user equipment waits until the timer is ended without performing any retransmission using the assigned region A (S560). And, the user equipment continues to wait for an uplink basic assignment A-MAP IE for retransmission with respect to the corresponding ACID (S560). If the user equipment receives the uplink basic assignment A-MAP IE for retransmission (S570), the timer (T_A-MAP) is ended.

In the above description in relation to FIG. 5, when the base station is incapable of assigning an uplink resource for retransmission, the base station may notify to the user equipment of the fact that an uplink resource for retransmission cannot be assigned from the current subframe.

Hereinafter, a method for indicating information that there is no assigned uplink resource at a base station to the user equipment. Such method of indication may be broadly divided into a case of defining and transmitting a new A-MAP IE type and a case of transmitting an already-existing uplink basic assignment A-MAP IE.

In the first case, the base station may newly define an A-MAP IE type, which notifies that there is not uplink resource allocation (or assignment) information. More specifically, the base station may transmit the newly defined A-MAP IE type to the user equipment. Alternatively, the base station may transmit information including indicating the fact that uplink resource allocation information with respect to the corresponding ACID and AI_SN (HARQ identifier sequence number) in the newly defined A-MAP.

In the second case, the base station may transmit an already-existing uplink basic assignment A-MAP IE to the user equipment. At this point, in order to notify that there is no uplink resource to be assigned, the base station may set a specific value for the resource index field value in the already-existing uplink basic assignment A-MAP IE, thereby transmitting processed uplink basic assignment A-MAP IE to the user equipment. Herein, the resource index is about information indicating where the resource assigned from the corresponding subframe is positioned and how large the size of the resource assigned from the corresponding subframe is. For example, the base station may either set all bits of the resource index field to 1 (e.g., setting the resource index field to 0b11111111111) or set all bits of the resource index field to 0 (i.e., 0b00000000000). In the description of the present invention, the specific value of the resource index field is shown to have all bits set to 1, for simplicity. Evidently, the specific value of the resource index field may also be shown to have all bits set to 0. In the resource index field, the specific value represents a value that is not used for resource allocation (or assignment) in an actual situation. For example, when all 11 bits of the resource index are set to 1, this may absolutely not be used in a system having a bandwidth of 5-10 MHz. And, in a system having a bandwidth of 20 MHz, this indicates that all LRUs (Logical Resource Units) of one subframe are assigned to the user equipment. Therefore, since an uplink control channel always exists in the uplink subframe, a situation where the base station assigns all LRUs of one subframe having the bandwidth of 20 MHz to the user equipment does not occur.

On the other hand, the base station may use a 1-bit field remaining from the uplink basic assignment A-MAP IE, so as to notify the user equipment that the uplink resource has not been assigned at the corresponding time point. Alternatively, the base station may combine the existing fields of the already-existing uplink basic assignment A-MAP IE, so as to notify the user equipment that there is no uplink resource assigned for the retransmission of the user equipment.

FIG. 6 illustrates another example indicating that an uplink resource which is to be assigned from the base station to the user equipment for retransmission does not exist.

Referring to FIG. 6, as described in FIG. 5, the base station transmits an uplink basic assignment A-MAP IE, which indicates that an uplink resource for data retransmission of the user equipment has been assigned to region A (S610). Then, the user equipment receiving the uplink basic assignment A-MAP IE from the base station may transmit new data through the resource region (region A) designated by the corresponding IE (S620). If an error occurs in the packet transmitted by the user equipment, and, therefore, if the base station is incapable of decoding the packet, the base station may transmit a NACK signal to the user equipment, in order to notify the user equipment of the error occurred in the transmitted packet (S630). Thereafter, if an uplink resource that is to be assigned to the corresponding user equipment does not exist at the point when an uplink resource for the retransmission of the user equipment is to be assigned, the base station may instruct the user equipment not to retransmit the data through an uplink, since there is to uplink resource to assigned (S640).

At this point, in order to notify the above-described fact, as described in FIG. 5, the base station may set all bits of the resource index field of the uplink basic assignment A-MAP IE to 1, thereby transmitting the processed uplink basic assignment A-MAP IE (S640). When the user equipment receives the uplink basic assignment A-MAP IE having all bits of the resource index set to 1 (S640), the user equipment does not transmit an HARQ sub-packet through a specific subframe of the frame receiving the A-MAP IE. Instead, the user equipment may transmit the HARQ sub-packet from a subframe having the same index of the next frame. Herein, the same subframe of the next frame refers to an uplink subframe having the same index as the index of the uplink subframe of the previous frame, wherein the uplink subframe is preset to perform HARQ sub-packet retransmission of the user equipment.

Meanwhile, when the user equipment receives another uplink basic assignment A-MAP IE from the base station, an HARQ sub-packet may be transmitted from the uplink subframe designated by the other uplink basic assignment A-MAP IE received from the base station. Herein, the other uplink basic assignment A-MAP IE received by the user equipment from the base station may correspond to the same frame as or a different frame from the frame transmitting the previous uplink basic assignment A-MAP IE, which include information indicating that an uplink resource for the retransmission of the user equipment cannot be assigned.

Table 1 shown below corresponds to an exemplary table showing a format of an uplink basic assignment A-MAP IE including information indicating that there is no uplink resource to be assigned to the user equipment.

TABLE 1

| | Size in | |
|---|---|---|
| Syntax | Bits | Description/Notes |
| UL Basic Assignment A-MAP | — | — |
| IE( ) { | | |
| A-MAP IE Type | 4 | UL Basic Assignment A-MAP IE |
| I_sizeoffset | 5 | Offset used to compute burst size index |
| ... | ... | ... |
| AI_SN | 1 | HARQ identifier sequence number |
| ACID | 3 | HARQ channel identifier |
| if (new transmission) { | | The AMS may know whether the transmission |
| | | of this IE is a new transmission or a |
| | | retransmission by using AI_SN and ACID. If |
| | | this A-MAP is used for retransmission, this A- |
| | | MAP does not include MIMO information (e.g., |
| | | CSM-PMI Indicator, SU-PMI Indicator, etc.) |
| CSM (Collaborative Spatial | 1 | Flag to indicate if both CSM and PMI are |
| Multiplexing)-PMI (Precoding | | signaled |
| Matrix Indication) Indicator | | 0b0: SU-MIMO with or without PMI indication, |
| | | or CSM without PMI indication |
| | | 0b1: SU MIMO with PMI indication |
| if (CSM-PMI Indicator == 0b0){ | | |
| Mₜ | 2 | Number of streams in transmission (Mₜ <= Nₜ), |
| | | up to 4 streams are supported for each AMS o |
| | | 0b00: 1 stream |
| | | 0b01: 2 streams |
| | | 0b10: 3 streams |
| | | 0b11: 4 streams |
| SU-PMI Indicator | 1 | Flag to indicate if both SU-MIMO and PMI are |
| | | signaled |
| | | 0b0: SU MIMO without PMI indication, or CSM |
| | | without PMI indication |
| | | 0b1: SU MIMO with PMI indication |
| ... | ... | ... |
| } | | |
| ... | ... | ... |
| } else { | | Retransmission |
| Resource allocation Indicator | 1 | 0b1: indicates that resource is not assigned |
| | | from this subframe |
| Reserved | TBD | Reserved bits |
| } | | |
| Reserved | TBD | Reserved bits |
| Padding | Variable | Padding to reach byte boundary |
| MCRC | [16] | 16 bit CRC masked by Station ID |
| } | — | — |

The uplink basic assignment A-MAP IE may include all of the MIMO (Multiple-Input Multiple-Output) information during the first transmission or during the retransmission. However, when a retransmission is performed with respect to the uplink, the MIMO information of the user equipment does not change with the first transmission. Therefore, when a retransmission is performed, and when the base station sends an uplink basic assignment A-MAP IE for an uplink resource assignment required for retransmission to the user equipment, MIMO-related information is not required to be sent to the A-MAP IE. When the user equipment receives an uplink basic assignment A-MAP IE for retransmission and uses the assigned resource region to transmit data to the base station, the user equipment may use the same MIMO information as that of the first transmission, so as to perform transmission.

Therefore, as shown in Table 1, a resource allocation indicator is included in the uplink basic assignment A-MAP IE for retransmission, so as to notify the user equipment whether the uplink resource for retransmission is assigned from the corresponding uplink subframe or whether the uplink resource is not assigned from the corresponding uplink subframe. As shown in Table 1, the resource allocation indicator may be signaled to the user equipment in 1-bit size. For example, if the resource allocation indicator is set to ‘1’, this indicates that the uplink resource for retransmission is not assigned in this subframe.

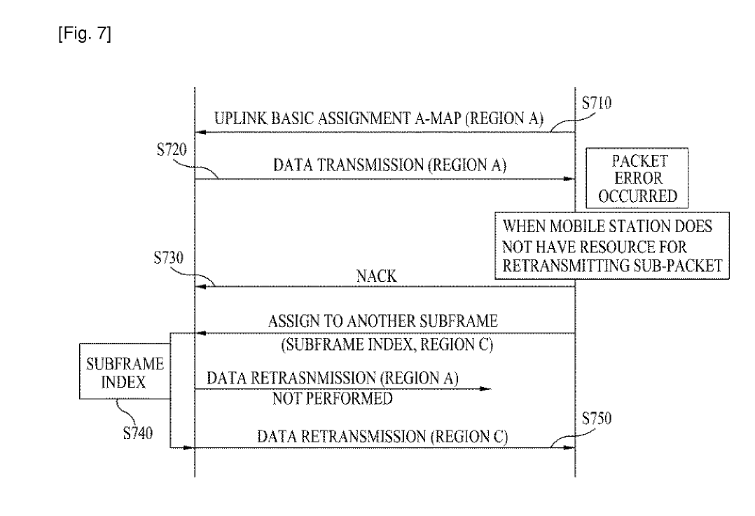

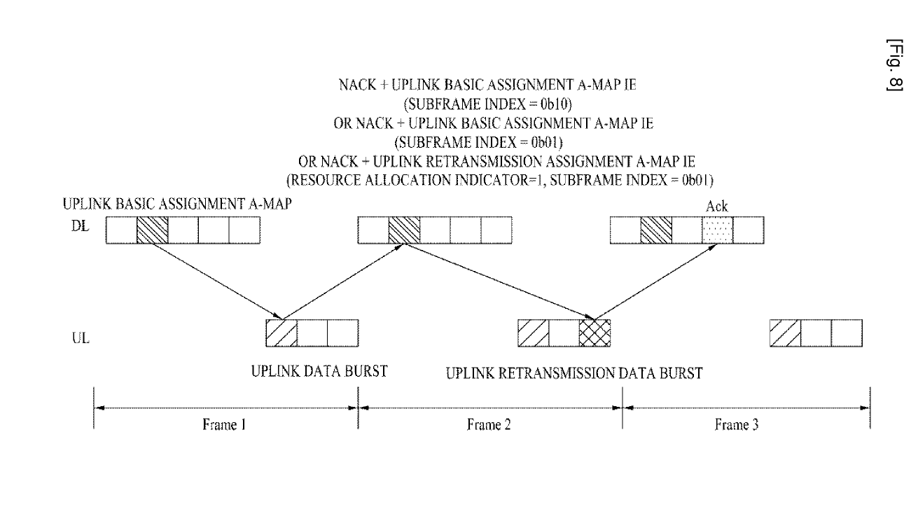

FIG. 7 illustrates another example indicating that an uplink resource which is to be assigned from the base station to the user equipment does not exist.

Referring to FIG. 7, as shown in S610 to S630 of FIG. 6, the user equipment is assigned with an uplink resource (region A) for first transmission (S710), and, then, the user equipment uses the assigned resource to transmit data (S720). Thereafter, when the base station fails to decode the data received from the user equipment, the base station transmits a NACK signal to the user equipment (S730). When the base station attempts to assign resource for retransmission due to the occurrence of an error in the packet transmitted from the user equipment at a designated time point, if the uplink resource for retransmission cannot be assigned from the corresponding subframe, the base station may notify the user equipment of the information that the resource for retransmission of the user equipment is assigned from the corresponding downlink subframe, which transmits the NACK signal to the user equipment, to another uplink subframe (S740). At this point, the information that the resource for the retransmission of the user equipment is being assigned from another subframe may include an index of the other uplink subframe, and information related to the region (e.g., region C) assigned from the other uplink subframe.

When the user equipment receives a NACK information and also receives information that the resource for retransmission of the user equipment is being assigned to another uplink subframe, instead of being assigned to the corresponding uplink subframe, from the base station (S740), instead of retransmitting the packet to the base station from the corresponding uplink subframe (region A), the user equipment may use the received resource allocation region information so as to retransmit a packet using another specific uplink subframe (region C) (S750).

Hereinafter, a method of the base station for assigning an uplink resource to another uplink subframe instead of the uplink subframe designated to the user equipment will now be briefly described.

Firstly, a new A-MAP IE type, which may assign an uplink resource from a subframe other than the subframe associated to the uplink allocation relevance, may be newly defined. When the base station is incapable of assigning the user equipment with an uplink resource from the uplink subframe associated to the allocation relevance, the base station may transmit a new A-MAP IE to the user equipment, so that a resource may be assigned from another subframe. The A-MAP IE for the retransmission of the user equipment may include subframe index information indicating after how many subframes from the uplink subframe associated with the uplink allocation relevance, to which the resource is to be allocated (or assigned), the uplink subframe is located (or positioned), and may also include resource region information from the corresponding subframe.

Secondly, the base station may transmit already-existing uplink basic assignment A-MAP IE to the user equipment. As described above, the uplink basic assignment A-MAP IE for the retransmission of the user equipment may not include MIMO information. Therefore, instead of the MIMO information, the uplink basic assignment A-MAP IE for the retransmission of the user equipment may include resource allocation information on the uplink subframe, which is located (or positioned) after how many subframes from the uplink subframe to which the already-existing resource is to be allocated (or assigned).

Table 2 below shows an exemplary format of the uplink basic assignment A-MAP IE for the retransmission of the user equipment.

TABLE 2

| | Size in | |
|---|---|---|
| Syntax | Bits | Description/Notes |
| UL Basic Assignment A-MAP | — | — |
| IE( ) { | | |
| A-MAP IE Type | 4 | UL Basic Assignment A-MAP IE |
| I_sizeoffset | 5 | Offset used to compute burst size index |
| ... | ... | ... |
| AI_SN | 1 | HARQ identifier sequence number |
| ACID | 3 | HARQ channel identifier |
| if (new transmission) { | | The AMS may know whether the transmission |
| | | of this IE is a new transmission or a |
| | | retransmission by using AI_SN and ACID. If |
| | | this A-MAP is used for retransmission, this A- |
| | | MAP does not include MIMO information (e.g., |
| | | CSM-PMI Indicator, SU-PMI Indicator, etc.) |
| CSM (Collaborative Spatial | 1 | Flag to indicate if both CSM and PMI are |
| Multiplexing)-PMI (Precoding | | signaled |
| Matrix Indication) Indicator | | 0b0: SU-MIMO with or without PMI indication, |
| | | or CSM without PMI indication |
| | | 0b1: SU MIMO with PMI indication |
| if (CSM-PMI Indicator == | | |
| 0b0){ | | |
| Mₜ | 2 | Number of streams in transmission (Mₜ <= Nₜ), |
| | | up to 4 streams are supported for each terminal o |
| | | 0b00: 1 stream |
| | | 0b01: 2 streams |
| | | 0b10: 3 streams |
| | | 0b11: 4 streams |
| SU-PMI Indicator | 1 | Flag to indicate if both SU-MIMO and PMI are |
| | | signaled |
| | | 0b0: SU MIMO without PMI indication, or CSM |
| | | without PMI indication |
| | | 0b1: SU MIMO with PMI indication |
| .. | ... | ... |
| } | | |
| ... | ... | ... |
| } else { | | Retransmission |
| Subframe Index | TBD | This indicates where the uplink subframe |
| | | allocation resource is positioned with respect to |
| | | the corresponding subframe |
| | | For example, if the field length is equal to 2 |
| | | bits, |
| | | 0b00: This is the corresponding frame |
| | | associated to Allocation relevance. Generally, |
| | | this is allocated to an uplink subframe |
| | | positioned 3 subframes after the current DL |
| | | subframe. |
| | | 0b01: This is allocated to an uplink subframe |
| | | positioned 1 subframe after the corresponding |
| | | uplink subframe. |
| | | 0b10: This is allocated to an uplink subframe |
| | | positioned 2 subframes after the corresponding |
| | | uplink subframe. |
| | | 0b11: This is allocated to an uplink subframe |
| | | positioned 3 subframes after the corresponding |
| | | uplink subframe. |
| } | | |
| Resource Index | 11 | 5 MHZ: 0 in first 2 MSB bits + 9 bits for |
| | | resource index |
| | | 10 MHz: 11 bits for resource index |
| | | 20 MHz: 11 bits for resource index |
| | | Resource index includes location and allocation |
| | | size |
| Reserved | TBD | Reserved bits |
| Padding | Variable | Padding to reach byte boundary |
| MCRC | [16] | 16 bit CRC masked by Station ID |
| } | — | — |

Referring to Table 2, the uplink basic assignment A-MAP IE for the retransmission of the user equipment may include resource allocation (or assignment) information indicating the uplink subframe, which is located (or positioned) after how many subframes from the uplink subframe associated with the allocation relevance, to which the resource is to be allocated (or assigned). Such resource allocation information may be indicated as a ‘subframe index field’ within the uplink basic assignment A-MAP IE. The subframe index field may have the size of 2 bits. Herein, ‘00’ indicates the corresponding frame associated with the allocation relevance. Generally, this may indicate that an uplink resource for the retransmission of the user equipment may be assigned (or allocated) to an uplink subframe positioned 3 subframes after the current downlink subframe, to which the A-MAP is being transmitted.

Also, ‘01’, ‘10’, and ‘11’ may indicate that an uplink resource for the retransmission of the user equipment may be assigned (or allocated) to an uplink subframe respectively positioned 1 subframe, 2 subframes, and 3 subframes after the uplink subframe associated with the allocation relevance. Furthermore, as shown in Table 2, the resource index may be signaled to the user equipment with a size of 11 bits. And, the resource index may include the allocation position and size.

Table 3 shown below corresponds to another exemplary format of an uplink basic assignment A-MAP IE including information indicating that there is no uplink resource to be assigned (or allocated) to the user equipment.

TABLE 3

| | Size in | |
|---|---|---|
| Syntax | Bits | Description/Notes |
| UL Basic | — | — |
| Assignment | | |
| A-MAP IE( ) { | | |
| A-MAP IE Type | 4 | UL Basic Assignment A-MAP IE |
| I_sizeoffset | 5 | Offset used to compute burst size index |
| ...... | ...... | ...... |
| Resource Index | 11 | 5 MHZ: 0 in first 2 MSB bits + 9 bits for |
| | | resource index |
| | | 10 MHz: 11 bits for resource index |
| | | 20 MHz: 11 bits for resource index |
| | | Resource index includes allocation position |
| | | and allocation size |
| | | If all bits of this field are set to 1, the user |
| | | equipment does not transmit an HARQ sub- |
| | | packet with respect to the ACID included in |
| | | this A-MAP IE. |
| ...... | ...... | ...... |
| Reserved | 1 | Reserved bits |
| } | — | — |

Referring to Table 3, the base station may set all bits of the resource index field of the uplink basic assignment A-MAP IE to 1, so as to notify that resource for the sub-packet corresponding to the ACID (HARQ channel identifier) included in the IE cannot be assigned (or allocated). The user equipment receiving such information does not retransmit corresponding HARQ sub-packet for the ACID (HARQ channel identifier).

Table 4 below shows another exemplary format of an uplink basic assignment A-MAP IE.

TABLE 4

| | Size in | |
|---|---|---|
| Syntax | Bits | Description/Notes |
| UL Basic Assignment A-MAP | — | — |
| IE( ) { | | |
| A-MAP IE Type | 4 | UL Basic Assignment A-MAP IE |
| I_sizeoffset | 5 | Offset used to compute burst size index |
| ... | ... | ... |
| AI_SN | 1 | HARQ identifier sequence number |
| ACID | 3 | HARQ channel identifier |
| if (new transmission) { | | The AMS may know whether the transmission |
| | | of this IE is a new transmission or a |
| | | retransmission by using AI_SN and ACID. If |
| | | this A-MAP is used for retransmission, this A- |
| | | MAP does not include MIMO information (e.g., |
| | | CSM-PMI Indicator, SU-PMI Indicator, etc.) |
| CSM (Collaborative Spatial | 1 | Flag to indicate if both CSM and PMI are |
| Multiplexing)-PMI (Precoding | | signaled |
| Matrix Indication) Indicator | | 0b0: SU-MIMO with or without PMI indication, |
| | | or CSM without PMI indication |
| | | 0b1: SU MIMO with PMI indication |
| if (CSM-PMI Indicator == 0b0){ | | |
| Mₜ | 2 | Number of streams in transmission (Mₜ <= Nₜ), |
| | | up to 4 streams per AMS supported o |
| | | 0b00: 1 stream |
| | | 0b01: 2 streams |
| | | 0b10: 3 streams |
| | | 0b11: 4 streams |
| SU-PMI Indicator | 1 | Flag to indicate if both SU-MIMO and PMI are |
| | | signaled |
| | | 0b0: SU MIMO without PMI indication, or CSM |
| | | without PMI indication |
| | | 0b1: SU MIMO with PMI indication |
| ... | ... | ... |
| } | | |
| ... | ... | ... |
| } else { | | Retransmission |
| Resource allocation Indicator | 1 | 0b1: indicates that resource is not assigned |
| | | from this subframe |
| If (resource allocatin | | |
| indicator==1) { | | |
| Subframe Index | TBD | This indicates where the uplink subframe |
| | | allocation resource is positioned with respect |
| | | to the corresponding subframe |
| | | For example, if the field length is equal to 2 |
| | | bits. |
| | | 0b00: This is allocated to an uplink subframe |
| | | positioned 1 subframe after the corresponding |
| | | uplink subframe. |
| | | 0b01: This is allocated to an uplink subframe |
| | | positioned 2 subframes after the |
| | | corresponding uplink subframe. |
| | | 0b10: This is allocated to an uplink subframe |
| | | positioned 3 subframes after the |
| | | corresponding uplink subframe. |
| | | 0b11: This is allocated to an uplink subframe |
| | | positioned 4 subframes after the |
| | | corresponding uplink subframe. |
| } | | |
| } | | |
| Resource Index | 11 | 5 MHZ: 0 in first 2 MSB bits + 9 bits for |
| | | resource index |
| | | 10 MHz: 11 bits for resource index |
| | | 20 MHz: 11 bits for resource index |
| | | Resource index includes location and |
| | | allocation size |
| Reserved | TBD | Reserved bits |
| Padding | Variable | Padding to reach byte boundary |
| MCRC | [16] | 16 bit CRC masked by Station ID |
| } | — | — |

Referring to Table 4, the uplink basic assignment A-MAP IE for retransmission of the user equipment may include a resource allocation indicator, a resource index field, and a subframe index field. At this point, if an uplink resource for retransmission of the user equipment is not assigned from the current frame (when (Resource allocation indicator)==1), the resource allocation indicator may include subframe index information indicating the subframe, which is located (or positioned) after how many subframes from the corresponding uplink subframe, to which the uplink resource for retransmission of the user equipment is to be allocated (or assigned).

Additionally, as shown in Table 4, the subframe index field may be signaled to the user equipment at the size of 2 bits. The subframe index shown in Table 4 indicates the uplink subframe, which is located (or positioned) after how many subframes from the uplink subframe associated with the allocation relevance, to which the uplink resource for retransmission of the user equipment is to be allocated (or assigned). Herein, ‘00’, ‘01’, ‘10’, and ‘11’ may indicate that a resource has been assigned (or allocated) to an uplink subframe each associated with the allocation relevance and respectively positioned 1 subframe, 2 subframes, 3 subframes, and 4 subframes after the uplink subframe associated with the allocation relevance. Furthermore, as shown in Table 2 described above, the resource index may be signaled to the user equipment with a size of 11 bits, and, herein, the resource index may include the allocation position and size.

As described above, the format of the uplink basic assignment A-MAP IE shown in Table 4 includes information on whether or not the base station includes uplink resource allocation information in the current A-MAP transmitted subframe, the format also includes information on how far apart the uplink allocation resource for retransmission of the user equipment is positioned from the allocation relevance uplink subframe, and the format also include position and size information of the assigned (or allocated) uplink resource.

Table 5 below shows a format of an uplink retransmission assignment A-MAP IE.

TABLE 5

| | Size in | |
|---|---|---|
| Syntax | Bits | Description/Notes |
| UL ReTx | — | — |
| Assignment | | |
| A-MAP | | |
| IE( ) { | | |
| A-MAP IE | 4 | UL ReTx Assignment A-MAP IE |
| Type | | |
| I_sizeoffset | 5 | Offset used to compute burst size index |
| ... | ... | ... |
| AI_SN | 1 | HARQ identifier sequence number |
| ACID | 3 | HARQ channel identifier |
| Subframe | TBD | This indicates where the uplink subframe |
| Index | | allocation resource is positioned with respect to |
| | | the corresponding subframe |
| | | For example, if the field length is equal to 2 |
| | | bits. |
| | | 0b00: This is allocated to an uplink subframe |
| | | positioned 1 subframe after the corresponding |
| | | uplink subframe. |
| | | 0b01: This is allocated to an uplink subframe |
| | | positioned 2 subframes after the corresponding |
| | | uplink subframe. |
| | | 0b10: This is allocated to an uplink subframe |
| | | positioned 3 subframes after the corresponding |
| | | uplink subframe. |
| | | 0b11: This is allocated to an uplink subframe |
| | | positioned 4 subframes after the corresponding |
| | | uplink subframe. |
| Resource | 11 | 5 MHZ: 0 in first 2 MSB bits + 9 bits for |
| Index | | resource index |
| | | 10 MHz: 11 bits for resource index |
| | | 20 MHz: 11 bits for resource index |
| | | Resource index includes location and allocation |
| | | size |
| Long TTI | 1 | Indicates number of subframes spanned by the |
| Indicator | | allocated resource. |
| | | 0b0: 1 subframe (default) |
| | | 0b1: 4 UL subframes for FDD or all UL |
| | | subframes for TDD |
| HFA | [4] | TBD |
| | | HARQ Feedback Allocation |
| ... | ... | ... |
| Reserved | TBD | Reserved bits |
| Padding | Variable | Padding to reach byte boundary |
| MCRC | [16] | 16 bit CRC masked by Station ID |
| } | — | — |

Referring to Table 5, when the base station is incapable of allocating (or assigning) resource for retransmission of the user equipment to an uplink subframe associated with allocation relevance, the base station may transmit an uplink retransmission assignment A-MAP IE to the user equipment in order to assign (or allocate) resource to another uplink subframe. Herein, the user equipment receiving the corresponding A-MAP from the base station may know (or be aware of) the fact that a resource has not been assigned (or allocated) from the uplink subframe associated with the downlink allocation relevance. Therefore, the user equipment does not transmit a packet, which is to be retransmitted from the uplink subframe associated with the uplink allocation relevance, and may use a resource assigned to the uplink subframe designated by the uplink retransmission assignment A-MAP, so as to transmit the retransmission packet. As described in Table 4, Table 5 may include a ‘subframe index’ field and a ‘resource index’ field.

FIG. 8 illustrates an exemplary method of the base station for indicating to the user equipment that the base station cannot assign a resource region for retransmission from an uplink subframe associated to an uplink assignment relevance.

Referring to FIG. 8, in order to designate an uplink resource region (region A) assigned for retransmission to the user equipment, the base station may transmit an uplink basic assignment A-MAP IE by using a second downlink subframe (810) of a first frame. The user equipment receiving the uplink basic assignment A-MAP IE from the base station may transmit a sub-packet of an HARQ burst to the base station through the resource region (region A) indicated by the IE from a subframe corresponding to an uplink allocation relevance (a first uplink subframe of the first frame) (820). When the base station fails to decode the packet transmitted from the user equipment, due to the occurrence of an error in the corresponding packet, in order to notify the occurrence of the error in the packet, the base station may transmit a NACK signal from the corresponding downlink subframe (a second downlink subframe of a second frame) (830) to the user equipment.

When the base station assigns a resource to the user equipment from the corresponding downlink subframe (the second downlink subframe of the second frame) (830), so that the user equipment can retransmit the erroneous packet (or packet having an error occurred therein), the resource for retransmission may not be assigned from the corresponding subframe. Accordingly, the base station may transmit A-MAP IEs (uplink basic assignment A-MAP IE or uplink retransmission assignment A-MAP IE) to the user equipment, wherein the A-MAP IEs (uplink basic assignment A-MAP IE or uplink retransmission assignment A-MAP IE) include information that the resource for retransmission of the user equipment is assigned from the downlink subframe (the second downlink subframe of the second frame) (830), which transmits the NACK signal to the user equipment, to another uplink subframe. When the user equipment receives the NACK signal and also receives information indicating that the resource for retransmission is assigned to another subframe from the base station, the user equipment does not transmit a retransmission packet to the base station from an uplink subframe associated with the allocation relevance (a first uplink subframe within the second frame) (840).

The user equipment may use subframe index information (e.g., subframe index value), which corresponds to resource allocation information included in the A-MAP IE, and the resource allocation region information from the assigned (or allocated) uplink subframe, so as to transmit a retransmission packet from a specific uplink subframe (a third uplink subframe of the second frame) (850). Thereafter, if the base station receives the packet transmitted from the third uplink subframe (850) of the second frame, thereby successfully decoding the received packet, the base station may transmit an ACK signal to the user equipment from a fourth downlink subframe (860) of the third frame, the fourth subframe (860) being positioned 3 subframes after the third subframe (850).

Table 6 shown below is an exemplary format of the uplink retransmission assignment A-MAP IE, when the base station transmits the uplink retransmission assignment A-MAP IE along with the NACK signal.

TABLE 6

| | Size in | |
|---|---|---|
| Syntax | Bits | Description/Notes |
| UL ReTx | — | — |
| Assignment | | |
| A-MAP | | |
| IE( ) { | | |
| A-MAP IE | 4 | UL ReTx Assignment A-MAP IE |
| Type | | |
| I_sizeoffset | 5 | Offset used to compute burst size index |
| ... | ... | ... |
| AI_SN | 1 | HARQ identifier sequence number |
| ACID | 3 | HARQ channel identifier |
| Resource | 1 | 0b0: indicates that resource is assigned to |
| allocation | | the corresponding uplink subframe |
| Indicator | | 0b1: indicates that resource is not assigned |
| | | to the corresponding uplink subframe |
| If(resource | | |
| allocation | | |
| indicator==1) { | | |
| Subframe | TBD | This indicates where the uplink subframe |
| Index | | allocation resource is positioned with respect |
| | | to the corresponding subframe |
| | | For example, if the field length is equal to 2 |
| | | bits. |
| | | 0b00: This is allocated to an uplink subframe |
| | | positioned 1 subframe after the |
| | | corresponding uplink subframe. |
| | | 0b01: This is allocated to an uplink subframe |
| | | positioned 2 subframes after the |
| | | corresponding uplink subframe. |
| | | 0b10: This is allocated to an uplink subframe |
| | | positioned 3 subframes after the |
| | | corresponding uplink subframe. |
| | | 0b11: This is allocated to an uplink subframe |
| | | positioned 4 subframes after the |
| | | corresponding uplink subframe. |
| } | | |
| Resource Index | 11 | 5 MHZ: 0 in first 2 MSB bits + 9 bits for |
| | | resource index |
| | | 10 MHz: 11 bits for resource index |
| | | 20 MHz: 11 bits for resource index |
| | | Resource index includes location and |
| | | allocation size |
| Long TT | 1 | Indicates number of subframes spanned by |
| I Indicator | | the allocated resource. |
| | | 0b0: 1 subframe (default) |
| | | 0b1: 4 UL subframes for FDD or all UL |
| | | subframes for TDD |
| HFA | [4] | TBD |
| | | HARQ Feedback Allocation |
| ... | ... | ... |
| Reserved | TBD | Reserved bits |
| Padding | Variable | Padding to reach byte boundary |
| MCRC | [16] | 16 bit CRC masked by Station ID |
| } | — | — |

Referring to Table 6, as described in FIG. 8, the base station may transmit the fact that a resource for retransmission of the user equipment cannot be assigned to the uplink subframe (840) associated with allocation relevance and a NACK signal along with the uplink retransmission assignment A-MAP IE (resource allocation indicator=1, subframe offset). When the base station cannot assign a resource for retransmission of the user equipment from the corresponding uplink subframe (840), the base station may transmit an uplink retransmission assignment A-MAP for assigning (or allocating) resource to another uplink subframe (850) to the user equipment. When the user equipment receives the corresponding A-MAP, the user equipment may know that resource has not been assigned to the uplink subframe (840) associated with uplink allocation relevance. Accordingly, the user equipment does not transmit a retransmission packet from the uplink subframe (840) associated with uplink allocation relevance. And, instead, the user equipment may transmit a retransmission packet by using a resource assigned to an uplink subframe (e.g., 860) designated by the uplink retransmission assignment A-MAP.

Table 7 below shows yet another exemplary format of an uplink retransmission assignment A-MAP IE, wherein the base station transmits the uplink retransmission assignment A-MAP IE to the user equipment along with the NACK signal.

TABLE 7

| | Size in | |
|---|---|---|
| Syntax | Bits | Description/Notes |
| UL ReTx Assignment A-MAP | — | — |
| IE( ) { | | |
| A-MAP IE Type | 4 | UL ReTx Assignment A-MAP IE |
| I_sizeoffset | 5 | Offset used to compute burst size index |
| ... | ... | ... |
| AI_SN | 1 | HARQ identifier sequence number |
| ACID | 3 | HARQ channel identifier |
| Subframe offset Indicator | 1 | |
| If(Subframe offset Indicator ==1) | | |
| { | | |
| Subframe offset | TBD | This indicates a downlink subframe having a |
| | | UL Basic Assignment A-MAP transmitted for |
| | | an uplink resource assignment. When a UL |
| | | ReTx Assignment A-MAP IE is calculated |
| | | from the transmitted downlink subframe, this |
| | | indicates the position of the subframe after |
| | | how many downlink subframes, based upon |
| | | the corresponding downlink subframe, |
| | | wherein the UL ReTx Assignment A-MAP IE |
| | | is transmitted. And, the uplink subframe is |
| | | not calculated. |
| | | For example, if the field length is equal to 3 |
| | | bits. |
| | | 0b000: This is allocated to a downlink |
| | | subframe positioned 1 subframe after the |
| | | corresponding downlink subframe. |
| | | 0b001: This is allocated to a downlink |
| | | subframe positioned 2 subframes after the |
| | | corresponding downlink subframe. |
| | | 0b010: This is allocated to a downlink |
| | | subframe positioned 3 subframes after the |
| | | corresponding downlink subframe. |
| | | 0b011: This is allocated to a downlink |
| | | subframe positioned 4 subframes after the |
| | | corresponding downlink subframe. |
| | | 0b100: This is allocated to a downlink |
| | | subframe positioned 5 subframes after the |
| | | corresponding downlink subframe. |
| | | 0b101: This is allocated to a downlink |
| | | subframe positioned 6 subframes after the |
| | | corresponding downlink subframe. |
| | | 0b110: This is allocated to a downlink |
| | | subframe positioned 7 subframes after the |
| | | corresponding downlink subframe. |
| | | 0b111: This is allocated to a downlink |
| | | subframe positioned 8 subframes after the |
| | | corresponding downlink subframe. |
| } | | |
| Padding | Variable | Padding to reach byte boundary |
| MCRC | [16] | 16 bit CRC masked by Station ID |
| } | — | — |

Referring to Table 7, as shown in Table 6, when the base station cannot assign a resource for retransmission of the user equipment from the corresponding uplink subframe, the uplink retransmission assignment A-MAP is transmitted to the user equipment. When the user equipment receives the uplink retransmission assignment A-MAP, the user equipment determines that resource is not assigned from the uplink subframe associated with uplink allocation relevance. Therefore, the user equipment does not retransmit the uplink burst from the previously assigned resource region with respect to the corresponding uplink subframe.

If a subframe offset indicator included in the uplink retransmission assignment A-MAP is set to 0, this indicates that the downlink subframe, to which the uplink basic assignment A-MAP for the uplink resource assignment is to be transmitted, does not include the subframe offset information. Therefore, since the user equipment does not know from which uplink subframe the resource is being assigned, the user equipment waits during a predetermined period of time for MAP (e.g., uplink basic assignment A-MAP) information including resource allocation information for the retransmission of an uplink burst to be received, as shown in FIG. 5. When the user equipment receives the MAP information for the resource allocation within the predetermined period of time, an uplink burst is transmitted from an uplink resource region designated by the MAP.

On the other hand, if a subframe offset indicator included in the uplink retransmission assignment A-MAP is set to 1, this indicates that subframe offset information on the uplink subframe being assigned from the uplink retransmission assignment A-MAP is included. The base station transmits an uplink resource assignment MAP (uplink basic assignment A-MAP IE or other resource assignment MAP) from a downlink subframe decided by the subframe offset to the user equipment. And, the user equipment goes to the subframe decided by the received subframe offset information, so as to receive the MAP for uplink resource assignment, thereby retransmitting an uplink burst from the corresponding resource region.

Instead of setting the subframe offset indicator to 0, as shown in Table 7 or Table 8 below, some of the subframe offset values (e.g., 0) may be used so as to notify the user equipment that resource has not been assigned from the corresponding uplink subframe associated with an uplink MAP relevance. If the subframe offset is set to 0, the user equipment waits for a predetermined time period in order to receive a MAP for uplink resource assignment from the base station.

Table 8 and Table 9 shown below respectively correspond to other exemplary formats of the uplink retransmission assignment A-MAP IE.

TABLE 8

| | Size in | |
|---|---|---|
| Syntax | Bits | Description/Notes |
| UL ReTx | — | — |
| Assignment | | |
| A-MAP | | |
| IE( ) { | | |
| A-MAP IE | 4 | UL ReTx Assignment A-MAP IE |
| Type | | |
| I_sizeoffset | 5 | Offset used to compute burst size index |
| ... | ... | ... |
| AI_SN | 1 | HARQ identifier sequence number |
| ACID | 3 | HARQ channel identifier |
| Subframe | TBD | This indicates where the uplink subframe |
| offset | | allocation resource is positioned with respect |
| | | to the corresponding subframe |
| | | For example, if the field length is equal to 2 |
| | | bits. |
| | | 0b00: This indicates that a resource for the |
| | | ACID is not assigned from uplink subframe |
| | | corresponding to UL MAP relevance. |
| | | 0b01: This is allocated to an uplink subframe |
| | | positioned 2 subframes after the |
| | | corresponding uplink subframe. |
| | | 0b10: This is allocated to an uplink subframe |
| | | positioned 3 subframes after the |
| | | corresponding uplink subframe. |
| | | 0b11: This is allocated to an uplink subframe |
| | | positioned 4 subframes after the |
| | | corresponding uplink subframe. |
| If(subframe | | |
| offset !=0) | | |
| Resource | 11 | 5 MHZ: 0 in first 2 MSB bits + 9 bits for |
| Index | | resource index |
| | | 10 MHz: 11 bits for resource index |
| | | 20 MHz: 11 bits for resource index |
| | | Resource index includes location and |
| | | allocation size |
| Long TTI | 1 | Indicates number of subframes spanned by |
| Indicator | | the allocated resource. |
| | | 0b0: 1 subframe (default) |
| | | 0b1: 4 UL subframes for FDD or all UL |
| | | subframes for TDD |
| HFA | [4] | TBD |
| | | HARQ Feedback Allocation |
| ... | ... | ... |
| Reserved | TBD | Reserved bits |
| Padding | Variable | Padding to reach byte boundary |
| MCRC | [16] | 16 bit CRC masked by Station ID |
| } | — | — |

TABLE 9

| | Size in | |
|---|---|---|
| Syntax | Bits | Description/Notes |
| UL ReTx | — | — |
| Assignment | | |
| A-MAP | | |
| IE( ) { | | |
| A-MAP IE | 4 | UL ReTx Assignment A-MAP IE |
| Type | | |
| I_sizeoffset | 5 | Offset used to compute burst size index |
| ... | ... | ... |
| AI_SN | 1 | HARQ identifier sequence number |
| ACID | 3 | HARQ channel identifier |
| Subframe | TBD | This indicates a downlink subframe having a |
| offset | | UL Basic Assignment A-MAP transmitted for |
| | | an uplink resource assignment. When a UL |
| | | ReTx Assignment A-MAP IE is calculated |
| | | from the transmitted downlink subframe, this |
| | | indicates the position of the subframe after |
| | | how many downlink subframes, based upon |
| | | the corresponding downlink subframe, |
| | | wherein the UL ReTx Assignment A-MAP IE |
| | | is transmitted. And, the uplink subframe is |
| | | not calculated. |
| | | For example, if the field length is equal to 3 |
| | | bits. |
| | | 0b000: This indicates that a resource for the |
| | | ACID is not assigned from uplink subframe |
| | | corresponding to UL MAP relevance. |
| | | 0b001: This is allocated to a downlink |
| | | subframe positioned 1 subframe after the |
| | | corresponding downlink subframe. |
| | | 0b010: This is allocated to a downlink |
| | | subframe positioned 2 subframes after the |
| | | corresponding downlink subframe. |
| | | 0b011: This is allocated to a downlink |
| | | subframe positioned 3 subframes after the |
| | | corresponding downlink subframe. |
| | | 0b100: This is allocated to a downlink |
| | | subframe positioned 4 subframes after the |
| | | corresponding downlink subframe. |
| | | 0b101: This is allocated to a downlink |
| | | subframe positioned 5 subframes after the |
| | | corresponding downlink subframe. |
| | | 0b110: This is allocated to a downlink |
| | | subframe positioned 6 subframes after the |
| | | corresponding downlink subframe. |
| | | 0b111: This is allocated to a downlink |
| | | subframe positioned 7 subframes after the |
| | | corresponding downlink subframe. |
| Padding | Variable | Padding to reach byte boundary |
| MCRC | [16] | 16 bit CRC masked by Station ID |
| } | — | — |

If the base station can assign an uplink resource within the maximum subframe offset value (e.g., 8 subframes in Table 7, and 7 subframes in Table 9), the subframe offset indicator may be set to 1, or the subframe offset value may be set to a value other than 0. If the base station cannot set the subframe offset value to a value other than 0, the subframe offset indicator may be set to 0 or the subframe offset value may be set to 0.

As described above, by receiving an uplink assignment A-MAP IE (this may be referred to as many terms, such as uplink basic assignment A-MAP IE, uplink retransmission assignment A-MAP IE, etc.) from the base station, information of the uplink resource assignment for the retransmission of the user equipment may be acquired. At this point, if all bits of the resource index field included in the uplink assignment A-MAP IE are set to 1, the subframe associated with the uplink assignment relevance of the current frame does not retransmit data (e.g., HARQ sub-packet). In this case, the data may be retransmitted from a subframe associated with the uplink assignment relevance of the next frame. By using this method, errors occurring in accordance with the uplink packet transmission, when the base station is incapable of assigning an uplink resource for retransmission of the user equipment, may be prevented.

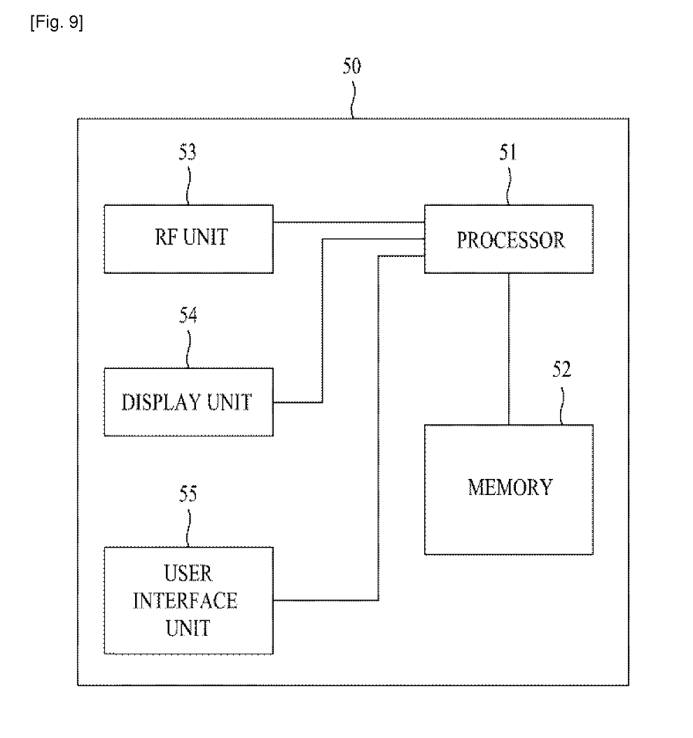

FIG. 9 is a block diagram showing constitutional element of a device 50. Device (50) may correspond to a UE or BS of FIG. 7. The mobile station (50) includes a processor (51), a memory (52), a radio frequency unit (RF unit) (53), a display unit (54), and a user interface unit (55). Layers of a radio (or wireless) interface protocol are implemented by the processor (51). The processor (51) provides a control plan and a user plan. The function of each layer may be implemented by the processor (51). The processor (51) may include a contention resolution timer. The memory (52) is connected to the processor (51) and stores an operating system, applications, and general files. If the mobile station (50) is a terminal, the display unit (54) may display diverse information and may use well-known elements, such as LCD (liquid crystal display), OLED (organic light emitting diode), and so on. The user interface unit (55) may be configured of a combination of well-known user interfaces, such as a keypad, a touch screen, and so on. The RF unit (53) is connected to the processor (51) and may transmit and receive radio signals. The RF unit (53) may include a transmission module (not shown) transmitting information controlled by the processor to the outside, and a reception module (not shown) receiving signals, information, and so on from the outside.

The processor (51) of the user equipment decodes the uplink basic assignment A-MAP IP received from the base station, and when the resource index field is set to a specific value, the processor (51) may control the user equipment, so that an corresponding HARQ sub-packet for an ACID, which is an HARQ channel identifier included in the uplink basic assignment A-MAP IE, cannot be retransmitted. Also, the processor (51) of the user equipment decodes the uplink basic assignment A-MAP IP received from the base station, and when the resource index field is set to a specific value, the corresponding HARQ sub-packet for the ACID, which is an HARQ channel identifier included in the first uplink basic assignment A-MAP IE, is not transmitted through a specific subframe of the first frame, which is predetermined in advance. Instead, the processor (51) may control the user equipment so that the HARQ sub-packet can be transmitted though a subframe of a second frame subsequent to the first frame, wherein the corresponding subframe has the same index as the specific subframe of the first frame. Furthermore, when the resource index field within the first uplink basic assignment A-MAP IE received from the base station is set to a specific value, and when the processor (51) of the user equipment receives a second resource index field from the first frame or the second frame through a second uplink basic assignment A-MAP IE, by using the subframe designated by the second resource index field, the processor (51) may control the system, so that the HARQ sub-packet corresponding to the ACID, which is an HARQ channel identifier included in the first uplink basic assignment A-MAP IE, can be retransmitted.

Layers of the radio interface protocol between the terminal and the network may be divided into a first layer (L1), a second layer (L2), and a third layer (L3), based upon 3 lower-level layers of an OSI (open system interconnection), which is well-known in the telecommunications system. A physical layer or PHY layer belongs to the first layer (L1), which provides information transmission services through the physical layer. An RRC (radio resource control) layer belongs to the third layer (L3) and provides control radio resources between the UE and the network. The UE and the network exchange RRC messages through the RRC layer.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments according to the present invention can be implemented by various means, for example, hardware, firmware, software, or their combination. If the embodiment according to the present invention is implemented by hardware, the embodiment of the present invention can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the embodiment of the present invention may be implemented by a type of a module, a procedure, or a function, which performs functions or operations described as above. A software code may be stored in a memory unit and then may be driven by a processor. The memory unit may be located inside or outside the processor to transmit and receive data to and from the processor through various means which are well known.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

The apparatus and method for retransmitting data based on HARQ scheme in wireless communication system is applied mobile communication system such as IEEE 802, 3GPP LTE, etc.

1-15. (canceled)

16. A method for retransmitting data using an HARQ (Hybrid Automatic Repeat reQuest) scheme at a mobile station (MS) in a wireless communication system, the method comprising:
receiving an uplink basic assignment A-MAP information element (IE) including a resource index field from a base station (BS),
wherein the MS does not transmit an HARQ subpacket corresponding to an ACID, an HARQ channel identifier, included in the uplink basic assignment A-MAP IE when the resource index field is set to a specific value.

17. The method of claim 16, wherein all bits of the specific value are set to 0 or 1.

18. The method of claim 16, wherein a size of the resource index field is an 11-bit, and
wherein the resource index field is set to 0b11111111111.

19. A method for retransmitting data using an HARQ (Hybrid Automatic Repeat reQuest) scheme at a mobile station (MS) in a wireless communication system, the method comprising:
receiving a first uplink basic assignment A-MAP information element (IE) including a resource index field in a first frame from a base station (BS),
wherein the MS does not transmit an HARQ subpacket corresponding to an ACID, an HARQ channel identifier included in the first uplink basic assignment A-MAP IE through a specific subframe in the first frame when the resource index field is set to a specific value, and
wherein the MS transmit the HARQ subpacket through a subframe having the same subframe index as the specific subframe of the first frame, the subframe is included in a second frame subsequent to the first frame.

20. The method of claim 19, wherein all bits of the specific value are set to 0 or 1.

21. The method of claim 20, wherein a size of the resource index field is an 11-bit.

22. A method for retransmitting data using an HARQ (Hybrid Automatic Repeat reQuest) scheme at a mobile station (MS) in a wireless communication system, the method comprising:
receiving a first uplink basic assignment A-MAP information element (IE) including a first resource index field in a first frame from a base station (BS);
receiving a second uplink basic assignment A-MAP information element (IE) including a second resource index field in the first frame or a second frame from the base station, when the first resource index field is set to a specific value; and
retransmitting an HARQ subpacket corresponding to an ACID, an HARQ channel identifier, included in the first uplink basic assignment A-MAP IE through a subframe designated by the second resource index field,
wherein the second resource index field is set to have a value different from the specific value of the first resource index field.

23. The method of claim 22, wherein all bits of the specific value of the first resource index field are set to 0 or 1.

24. The method of claim 22, wherein the subframe designated by the second resource index field is a subframe corresponding to a value set for the second resource index field.

25. The method of claim 22, wherein a size of each of the first resource index field and the second resource index field is a 9-bit or an 11-bit.

26. A mobile station (MS) apparatus for retransmitting data using an HARQ (Hybrid Automatic Repeat reQuest) scheme in a wireless communication system, the MS apparatus comprising:
a receiving module configured to receive an uplink basic assignment A-MAP information element (IE) including a resource index field from a base station (BS); and
a processor configured to control the MS does not transmit an HARQ subpacket corresponding to an ACID, an HARQ channel identifier, included in the uplink basic assignment A-MAP IE, when the resource index field is set to a specific value.

27. The MS apparatus of claim 26, wherein all bits of the specific value are set to 0 or 1.

28. The MS apparatus of claim 26, wherein a size of the resource index field is an 11-bit, and
wherein the resource index field is set to 0b11111111111.

29. A mobile station (MS) apparatus for retransmitting data using an HARQ (Hybrid Automatic Repeat reQuest) scheme in a wireless communication system, the MS apparatus comprising:
a receiving module configured to receive a first uplink basic assignment A-MAP information element (IE) including a resource index field in a first frame from a base station (BS);
a processor configured to control the MS does not transmit an HARQ subpacket corresponding to an ACID, an HARQ channel identifier, included in the first uplink basic assignment A-MAP IE through a specific frame in the first frame when the resource index field is set to a specific value, and control the MS transmits the HARQ subpacket through a subframe having the same subframe index as the specific subframe of the first frame, the subframe is included in a second frame subsequent to the first frame; and
a transmitting module configured to transmit the HARQ subpacket through the subframe of the second frame having the same subframe index as the specific subframe of the first frame.

30. A mobile station (MS) for retransmitting data using an HARQ (Hybrid Automatic Repeat reQuest) scheme in a wireless communication system, the MS apparatus comprising:
a receiving module configured to receive a first uplink basic assignment A-MAP information element (IE) including a first resource index field in a first frame from a base station (BS);
a processor configured to control the MS retransmits an HARQ subpacket corresponding to an ACID, an HARQ channel identifier, included in the first uplink basic assignment A-MAP IE through a subframe designated by a second resource index field, when the first resource index field is set to a specific value and when receiving a second uplink basic assignment A-MAP information element (IE) including the second resource index field in the first frame or a second frame from the base station (BS); and
a transmitting module configured to transmit the HARQ subpacket corresponding to the ACID, the HARQ channel identifier, included in the first uplink basic assignment A-MAP IE through the subframe designated by the second resource index field,
wherein the second resource index field is set to have a value different from the specific value.
